(19) United States
(12) Patent Application Publication
(10) Pub. No.: US 2009/0218418 A1
(43) Pub. Date: Sep. 3, 2009

(54) Atomising Nozzle and an Aerosol Canister Comprising an Atomising Nozzle

(75) Inventor: Rajab Sharief, Manchester (GB)

Correspondence Address: CHERNOFF, VILHAUER, MCCLUNG & STENZEL, LLP, 601 SW Second Avenue, Suite 1600, PORTLAND, OR, 97204-3157, US

(73) Assignee: INCRO LIMITED, WEST MIDLANDS (GB)

(21) Appl. No.: 11/989,373

(22) PCT Filed: Jul. 20, 2006
(86) PCT No.: PCT/GB2006/002745

§ 371 Date: Apr. 20, 2009

(30) Foreign Application Priority Data
Aug. 4, 2005 (GB) 0516024.7

(51) Int. Cl. B05B 1/02

(52) U.S. Cl. 239/338; 239/589

(57) ABSTRACT

An atomising nozzle (10) has an inlet (16), an outlet orifice (21) and an internal fluid flow passageway (20) which connects the inlet (16) to the outlet orifice (21). The nozzle (10) has a body with two component parts (12A, 12B) each component part having an abutment surface (22, 24) which contacts a corresponding abutment surface on the other of the parts. At least one of the abutment surfaces has at least one groove and/or recess (26a-34a; 26b-34b) therein to define part of the fluid flow passageway (20), including an expansion chamber (28). The body has a fixed partition means (44) which extends into the expansion chamber (28) to define one or more than one constricted openings (48) through which fluid is constrained to flow. The constricted opening has a cross sectional area larger than that of the final outlet orifice (21) and is positioned outwardly of an axially central region (52) of the expansion chamber (28) so that the partition means (44) blocks the flow of fluid through said axially central region. At least one of the constricted opening(s) (48) is non-circular when viewed in lateral cross-section.

The present invention relates to an atomising nozzle. More particularly, but not exclusively, the present invention relates to an atomising nozzle for an aerosol canister and to an aerosol canister comprising such an atomising nozzle.

Nozzles are often used to provide a means of generating sprays of various fluids. In particular, nozzles are commonly fitted to the outlet valves of pressurised fluid-filled containers, such as so-called “aerosol canisters”, to provide a means by which the fluid stored in the container can be dispensed in the form of a spray or mist. A large number of commercial products are presented to consumers in this form, including, for example, antiperspirant sprays, de-odorant sprays, perfumes, air fresheners, antiseptics, paints, insecticides, polish, hair care products, pharmaceuticals, water and lubricants. In addition, pump or trigger-actuated nozzle arrangements, i.e. arrangements where the release of fluid from a non-pressurised container is actuated by the operation of a manually operable pump or trigger that forms an integral part of the arrangement, are also frequently used to generate a spray or mist of certain fluid products. Examples of products that are typically dispensed using a pump or trigger nozzle device include various lotions, insecticides, as well as various garden and household sprays. Nozzles are also used in many industrial applications to deliver a fluid or mixture of fluids in the form of a spray.

Nozzle arrangements typically comprise a fluid flow passageway which leads from an inlet to an outlet orifice. A spray is generated when a fluid is caused to flow through a nozzle arrangement under pressure. To achieve this effect, the nozzle arrangement is configured to cause the fluid stream passing through the nozzle to break up or “atomise” into numerous droplets as it is ejected through the outlet orifice to form a spray or mist. It is also known to provide a swirl chamber next to the outlet to cause the fluid to spin as it passes through the outlet.

The optimum size of the droplets required in a particular spray depends primarily on the particular product concerned and the application for which it is intended. For example, a pharmaceutical spray that contains a drug intended to be inhaled by a patient (e.g. an asthmatic patient) usually requires very small droplets, which can penetrate deep into the lungs. In contrast, a polish spray preferably comprises spray droplets with larger diameters to promote the impaction of the aerosol droplets on the surface that is to be polished and, particularly if the spray is toxic, to reduce the extent of inhalation.

The size of the aerosol droplets produced by such conventional nozzle arrangements is dictated by a number of factors, including the dimensions of the outlet orifice and the pressure with which the fluid is forced through the nozzle. However, problems can arise if it is desired to produce a spray that comprises small droplets with narrow droplet size distributions, particularly at low pressures. The use of low pressures for generating sprays is becoming increasingly desirable because it enables low pressure nozzle devices, such as the manually-operable pump or trigger sprays, to be used instead of more expensive pressurised containers and, in the case of the pressurised fluid-filled containers, it enables the quantity of propellant present in the spray to be reduced, or alternative propellants which typically produce lower pressures (e.g. compressed gas) to be used. The desire to reduce the level of propellant used in aerosol canisters is a topical issue at the moment and is likely to become more important in the future due to legislation planned in certain countries, which proposes to impose restrictions on the amount of propellant that can be used in hand-held aerosol canisters. This is a particular issue for propellants which contain volatile organic compounds (vocs) such as butane which have been found to be harmful to the environment. The reduction in the level of propellant causes a reduction in the pressure available to drive the fluid through the nozzle arrangement and also results in less propellant being present in the mixture to assist with the droplet break up.

A further problem with known pressurised aerosol canisters fitted with conventional nozzle arrangements is that the size of the aerosol droplets generated tends to increase during the lifetime of the aerosol canister, particularly towards the end of the canisters life as the pressure within the canister reduces as the propellant becomes gradually depleted. This reduction in pressure causes an observable increase in the size of the aerosol droplets generated and thus, the quality of the spray produced is compromised.

The problem of providing a high quality spray at low pressures is further exacerbated if the fluid concerned has a high viscosity because it becomes harder to atomise the fluid into sufficiently small droplets.

It has been found that that size and/or the size distribution of the droplets produced at the outlet orifice of a nozzle can be controlled by incorporating a number of different control features into the fluid flow passageway between the inlet and the outlet which modify the characteristics of the fluid as it flows through the passageway. For example, it has been found to be particularly beneficial to form two or more expansion chambers along the fluid passageway, each chamber having a constricted inlet opening arranged so that the fluid is sprayed into the chamber. This and other suitable control features are disclosed in WO 01/89958 A1, the content of which is incorporated in its entirety. Similar effects have also been found by the use in the fluid flow passageway of expansion chambers which are shaped so as to modify the characteristics of the fluid passing through. A number of such shaped expansion chambers are described in WO 2005/005055, the content of which is also incorporated herein in its entirety.

Whilst the use of shaped expansion chambers and other known control features have been shown to be effective in modifying the droplet size/size distribution, there is a need to develop other arrangements that can be introduced into a nozzle to affect the droplet size/size distribution in order that nozzle performance can continue to be improved.

Due to the increasing complexity of nozzle design, it is often necessary for a nozzle to be manufactured as a split-body type nozzle having a body with two parts which are assembled together to define various features of the nozzle between them. Opposing faces of the two parts have abutment surfaces that are contacted together when the parts are assembled. Also formed on the opposing faces are various formations, such as grooves, recesses or protrusions, which define at least part of the flow passage and other features of the nozzle.

It is a particular object of the invention to provide an improved split-body type nozzle which overcomes or at least mitigates some of the disadvantages of the prior art nozzles.

Accordingly, it is an object of the present invention to provide an atomising nozzle arrangement having a split body that is adapted to generally reduce the size of the droplets generated when compared with conventional nozzle devices and which provides a narrow droplet size distribution. In addition, it is an object of the present invention to provide a nozzle arrangement having a split-type body that is adapted to enable small droplets of fluid to be generated at low pressures, i.e. when fluids containing reduced or depleted levels of propellant, or a relatively low-pressure propellant such as compressed gas, is used, or a low-pressure system is used, such as a pump or trigger-actuated nozzle arrangement. It is a further object of the invention to provide an aerosol canister fitted with such a nozzle.

In accordance with a first aspect of the invention, there is provided an atomising nozzle having an inlet through which fluid can enter the nozzle, an outlet orifice through which fluid can be ejected from the nozzle in the form of an atomised spray, and an internal fluid flow passageway which connects said inlet to said outlet orifice, said nozzle comprising a body having two component parts, each component part having an abutment surface which contacts a corresponding abutment surface on the other of the parts, at least one of the abutment surfaces having at least one groove and/or recess formed therein to define at least part of the fluid flow passageway including an expansion chamber, characterised in that the body further comprises a fixed partition means extending into the expansion chamber to define one or more constricted openings through which fluid is constrained to flow in order to pass from one side of the partition to the other within the chamber, the, or each, constricted opening having a cross sectional area larger than that of the final outlet orifice and being positioned outwardly of an axially central region of the expansion chamber so that the partition means blocks the flow of fluid through said axially central region, the, or at least one of the, constricted opening(s) being non-circular when viewed in lateral cross-section.

The partition means may comprise one or more projections extending into the expansion chamber.

The partition means may comprise a projection on the abutment surface of one of the parts of the body which extends into a groove or recess in the other part of the body.

In one embodiment, the expansion chamber is defined by means of corresponding recesses in the abutment surfaces of the two component parts of the body and the projection extends from a surface of the recess in one of the parts of the body into the recess in the other of the parts of the body.

In an alternative embodiment, the expansion chamber is defined by means of corresponding recesses in the abutment surfaces of the two parts of the body and the partition means comprises two projections, each projection extending inwardly toward the centre of the expansion chamber from a surface of the recess in one of the parts of the body.

The, or at least one of the, constricted opening(s) may be formed by means of a hole or opening through the, or one of the, projection(s).

The, or at least one of the, constricted opening(s) may be formed between a periphery of the, or one of the, partition(s) and a wall of the expansion chamber.

The expansion chamber may be shaped.

A surface of the, or at least one of the, constricted opening(s) may be textured.

The size and/or shape of the, or at least one of the, constricted opening(s) may vary in a longitudinal direction of the expansion chamber.

There may be two or more of said partition means extending into the expansion chamber.

The partition means may block the flow of fluid through an axially central region of the expansion chamber which has a cross sectional area larger than that of the outlet orifice.

The outlet orifice may be provided in an insert which is received in body.

The nozzle may have more than one outlet orifice.

The nozzle may be adapted for use with an aerosol dispenser.

In accordance with a second aspect of the invention, there is provided an aerosol canister comprising a nozzle in accordance with the first aspect of the invention.

The aerosol canister may comprise a propellant containing vocs such as butane.

Several embodiments of the invention will now be described, by way of example only, with reference to the accompanying drawings, in which:

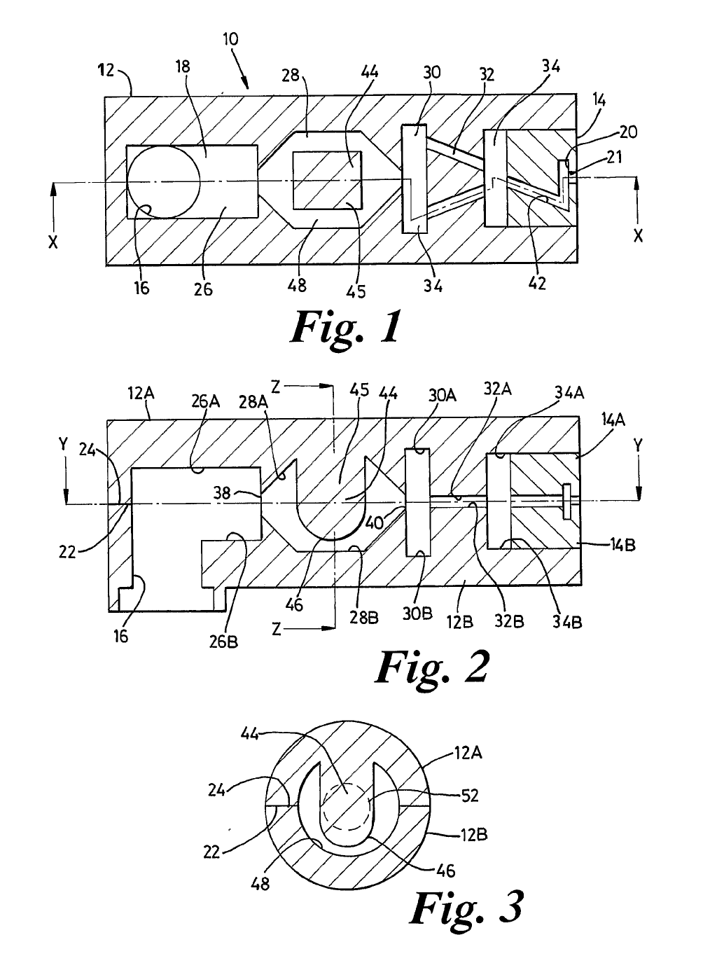

FIG. 1 is a longitudinal cross sectional view through a nozzle arrangement in accordance with the invention, taken on line Y-Y of FIG. 2,

FIG. 2 is a longitudinal cross sectional view of the nozzle arrangement of FIG. 1, taken on line X-X of FIG. 1;

FIG. 3 is a lateral cross sectional view of the nozzle arrangement taken on line Z-Z of FIG. 2; and

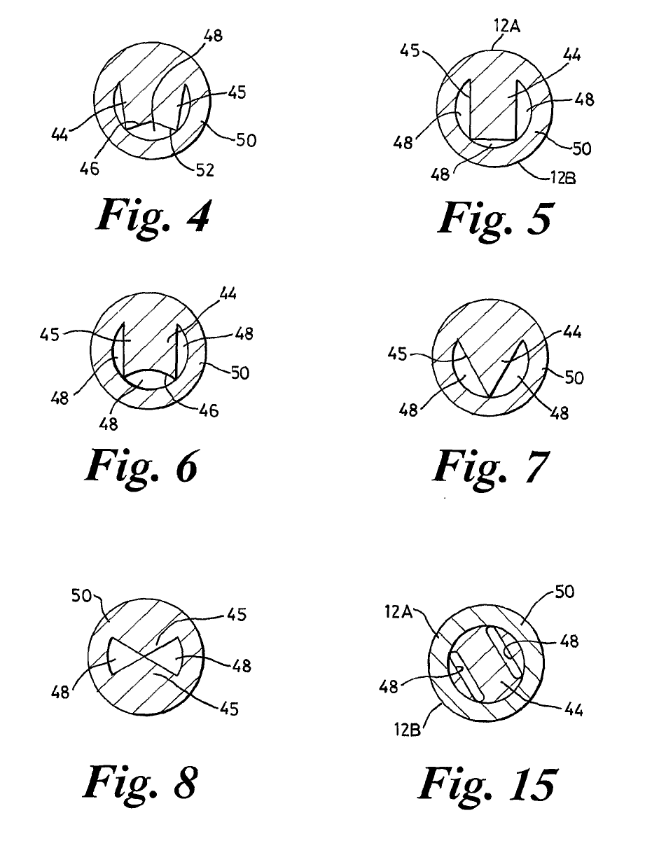

FIGS. 4 to 16 are views similar to FIG. 3, each showing a differently configured partition means forming part of a nozzle arrangement in accordance with the invention.

For the reader's assistance, a number of the terms used throughout this specification will now be defined.

The term “expansion chamber” is used herein to mean an internal chamber forming part of a fluid flow passageway which is usually (but not necessarily) circular in lateral cross-section, into which fluid passing though the passageway enters through an inlet orifice and exits through an outlet orifice, both the inlet orifice and the outlet orifice having a cross sectional area which is smaller than the largest cross sectional area of the chamber in between.

The term “shaped” in reference to an expansion chamber is used herein to mean that the chamber consists of more than a simple cylindrical cavity and may include tapered or constricted parts, and parts of non-circular cross section.

The term “swirl chamber” is used herein to mean an internal chamber forming part of a fluid flow passageway that is configured to impart a rotational and/or swirling motion to a fluid stream passing through the chamber during use. Expansion chambers and swirl chambers are further defined in WO 01/89958, the entire contents of which are incorporated herein by reference.

The term “constricted” or “constriction” in reference to part of the fluid flow passageway or to part of an expansion chamber is used herein to mean a part of the passageway or chamber, as the case may be, having a smaller cross-sectional area than the parts of the passageway or chamber immediately upstream and/or down steam of the part in question.

FIGS. 1 to 3 show an atomising nozzle arrangement 10 in accordance with the present invention. The nozzle comprises a body 12 and an insert 14. The main body 12 defines an inlet 16 and a first part of a fluid flow passageway 18. The insert 14 is received in the main body 12 and defines a further part of the fluid flow passageway having a swirl chamber 20 and an outlet orifice 21.

The main body 12 is a split type body and comprises two component parts 12A and 12B having mutually engaging abutment surfaces 22, 24 which lie in a plane containing the line Y-Y in FIG. 2. As the nozzle arrangement 10 is shown in FIG. 2, the abutment surfaces 22, 24 lie in a horizontal plane with the component part 12A being an upper part and the component part 12B being a lower part. However, it will be appreciated that the nozzle arrangement can be used in any orientation. It will also be appreciated that body 12 could be split vertically rather than horizontally or in any other orientation.

A series of interconnected grooves and recess 26a to 34a and 26b to 34b are formed in the abutment surfaces 22, 24 respectively, such that when the abutment surfaces are in contact, as shown in FIG. 2, they define the first part of the fluid flow passageway 18. The inlet 16 is formed in the lower (as shown) component part 12B and connects to a first chamber 26 of the fluid flow passageway 20 which is defined by the corresponding recesses or grooves 26a, 26b. A constricted inlet 38 leads from the first chamber 26 into a second shaped expansion chamber 28 having frusto conical ends. A constricted outlet 40 leads from the shaped expansion chamber 28 into a further expansion chamber 30 from which two angled flow passages 32, defined by grooves 32a, 32b, direct fluid into a final expansion chamber 34. The insert 14 is located in an outer end of the final expansion chamber 34 and has an angled inlet passage 42 which directs the fluid into the swirl chamber 20 tangentially, so as to cause the fluid to spin within the swirl chamber 20 before exiting the nozzle arrangement through the outlet orifice 21 in the form of a spray.

In an alternative embodiment, the insert 14 may have more than one inlet passage 42 to direct fluid into the swirl chamber 20. For example, two inlet passages 42 may be provided each directing a portion of the fluid flow into the swirl chamber. The inlet passages 42 may direct the fluid into the swirl chamber 20 tangentially or counter tangentially from the same or from opposite sides of the chamber.

The insert 14 is also formed by two component parts 14A, 14B with abutment surfaces which contact one another when the parts are assembled. In a manner similar to the main body, the inlet passage 42, the swirl chamber 20 and the outlet orifice 21 are defined be means of grooves and or recesses in one or both of the abutment surfaces.

The main body 12 and the insert 14 can be made of any suitable materials, which may be the same or different, and using any suitable methods. For example, the component parts 12A, 12B of the main body may be made of a metallic material or they may be formed of plastics material. Where the component parts 12A, 12B of the main body 12 are manufactured from plastics material they may be produced using injection moulding techniques. In a particularly advantageous arrangement, the component parts 12A, 12B are produced by injection moulding as a single integral item in which the two parts 12A, 12B are interconnected by means of a flexible hinge which allows the parts to be moved to bring the abutment surfaces 22, 24 into contact. The component parts 12A, 12B of the main body may be permanently joined to each other once they have been assembled, for example by bonding or by over moulding, or welding, or they may remain separable to enable the fluid flow passage to be cleaned. The component parts 14A, 14B of the nozzle 14 can be manufactured in a similar manner.

Whilst the present embodiment comprises a main body 12 and an insert 14, it should be appreciated that the use of an insert is not essential to the claimed invention and could be omitted. In such an arrangement, the whole of the fluid flow passageway 18 and the outlet orifice 21 would be formed between the component parts 12A and 12B of the main body.

In accordance with the invention, a fixed partition means 44 is provided in the fluid flow passageway 18 within the shaped expansion chamber 28. The partition means 44 in this embodiment comprises a rectangular projection 45 with a curved or hemispherical distal end 46. The projection 45 projects from the base of the recess 28a in the abutment surface 22 of the upper (as shown) part 12A of the main body. As can be seen best in FIGS. 2 and 3, the projection 45 is arranged so as to extend into the corresponding recess 28b formed in the abutment surface 24 of the other main body part 12B. The projection 45 is just slightly narrower than the chamber 28 and the distal end 46 is spaced from the lower surface of the chamber 28 so that a generally crescent shaped gap 48 is defined between the outer surface of the projection and the walls 50 of the chamber. The gap 48 forms a constricted opening 48 through which the fluid is forced to flow as it passes through the chamber 28 from one side of the projection to the other in the chamber. Thus, the partition means divides the chamber 28 into two so that the fluid must flow through the constricted openings 48 to pass from the inlet side of the chamber to the outlet side.

The presence of the partition means 44, which forces the fluid to pass through the constricted opening 48 around the sides of the chamber, disrupts the flow of the fluid through the chamber 28. This has been shown to have an effect on the size and size distribution of the droplets produced at the outlet orifice 21. Differently shaped or configured partition means 44 which create differently shaped constricted fluid flow openings have been found to have different effects on the fluid passing through the nozzle arrangement. Thus it is possible for a designer to fine tune a nozzle arrangement using a partition means in accordance with the invention, possibly used together with any of the other known control features discussed above, to produce a nozzle arrangement which provides the required droplet size and/or droplet size distribution for a particular application dependent on the characteristics of the fluid.

In the present embodiment, a constricted fluid flow opening 48 is created between the projection 45 and the walls of the chamber 28. However, in alternative embodiments one or more holes may be formed through the partition means 44 to create the constricted fluid flow opening(s). Where holes are provided through the partition means 44, the partition means 44 could extend across the whole of the chamber 28 so that all of the fluid passes through the one or more holes or it may be arranged that some fluid passes through a gap between the partition means and the wall or walls of the chamber whilst the rest passes through the one or more holes. The surfaces of openings 48 through which the fluid passes can be smooth or they can be textured or have various formations to vary the effect on the fluid.

The partition means 44 may be short or long and the shape of the openings may be constant in the direction of flow or they may vary over their length. Thus in the present embodiment, the distal end 46 of the projection 45 is curved both in a lateral or transverse direction across the fluid flow passage 20 as shown in FIG. 3, and in a longitudinal direction of the passageway 20 as shown in FIG. 2. Typically, a partition means will have a length in the range of 0.5 to 4 mm, though a length in the range of 1-2 mm may be more usual. The partition means may have a diameter (i.e. width and/or height) in the range of 0.5 to 6 mm, with a diameter in the range of 2 to 4 mm being more usual. It should be understood, however, that the invention in its broadest sense is not limited to nozzle arrangements having partition means with a length and/or diameter falling within the above mentioned ranges. The expansion chamber 28 can be of any shape.

Where there is only one constricted opening 48, the opening is non-circular when viewed in lateral cross section (that is to say in a direction transverse to the general direction of flow of the fluid through the chamber) as shown in FIG. 3. Where there is more than one constricted opening, at least one of the openings 48 is non-circular when viewed in lateral cross section. The constricted opening or openings 48 are each positioned outwardly of an axially central region of the chamber, which is indicted by the dashed lines 52 in FIG. 3. Thus the partition 44 blocks the flow of fluid through the axially central region of the chamber 28, forcing the fluid to flow outwardly around the periphery of the chamber. The partition means preferably blocks the flow of fluid through an axially central region 52 of the chamber which has a cross sectional area larger than that of the outlet orifice 21. It has been found that the use of a partition means in accordance with the invention to deflect the fluid away from the centre of the chamber is particularly advantageous. The partition means is fixed, which is to say that it is relatively rigid and is not significantly deflected by the flow of fluid through the chamber 28.

FIGS. 4 to 16 show examples of different partition means 44 which create differently shaped constricted openings 48 through which the fluid flows. FIGS. 4 to 9 illustrate various partition means 44 each comprising a projection 45 which extends into an expansion chamber 28 in a manner similar to that of the first embodiment. In each case, the shape of the projection 45 is varied in order to produce differently sized and shaped constricted fluid flow openings 48 between the projection 45 and the walls 50 of the expansion chamber 28.

In FIG. 4, the sides of the projection 45 taper inwards towards the distal end 46 and the distal end has a V shaped indentation 52. This produces an inverted, generally “M” shaped opening 48 between the projection 45 and the wall 50 of the expansion chamber 28.

The projection shown in FIG. 5 has straight sides and defines three constricted fluid flow openings 48 with the wall 50. The openings form a generally crescent shape and could be merged into one continuous opening if the distal end of the projection were spaced further from the walls 50 of the expansion chamber.

The projection 45 in FIG. 6, is similar to that of FIG. 5, except that the distal end 46 is curved inwardly. The distal end may be curved in two dimensions so as to form a concave dish shape or only in one dimension to form a U shaped channel or trough.

FIG. 7, illustrates the use of a triangular projection 45 as the partition means to define a pair of constricted fluid flow openings 48 on either side.

In FIG. 8, two triangular projections 45 extend from either side of the expansion chamber 28. As shown, the apexes of the projections meet in the centre to define two triangular shaped constricted fluid flow openings 48.

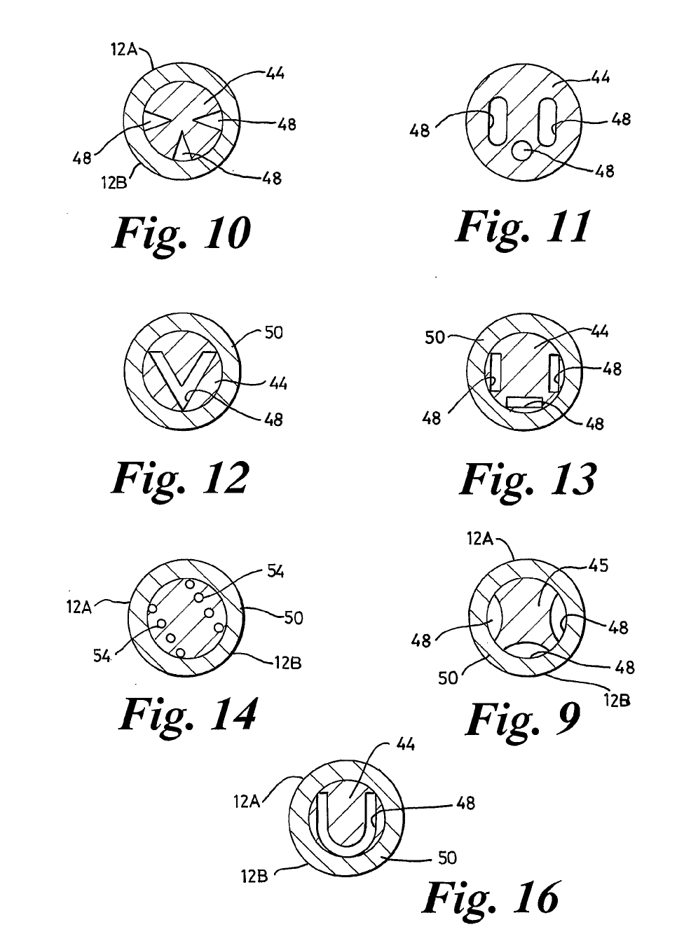

The projection 45 in FIG. 9 has three curved indentations spaced around its periphery which define constricted fluid flow openings 48 with the wall 50 of the expansion chamber.

A similar pattern of constricted flow openings 48 to those provided in the embodiments of FIGS. 4 to 9 could be produced by forming appropriately shaped holes though a partition means 44 which extends across the whole of the expansion chamber 28.

FIGS. 10 to 16 illustrate different embodiments in which the partition means 44 extends across the whole of the expansion chamber and the constricted fluid flow openings 48 are provided in the form of holes through the partition means 44. In these embodiments, the partition means may be in the form of a wall which is formed integrally with one of the component parts 12A, 12B of the main body portion.

In FIG. 10, three triangular slots are formed in the periphery of the partition means 44 to define constricted fluid flow openings 48 with the wall 50 of the expansion chamber 28.

The embodiment shown in FIG. 11, illustrates a partition means 44 having three holes to provide constricted fluid flow openings 48.

FIG. 12 illustrates a partition means 44 in which a constricted fluid flow opening 48 is formed by a “V” shaped hole through the partition means 44.

In FIG. 13, the partition means 44 has three rectangular holes arranged close to its periphery to form constricted fluid flow openings 48.

In the embodiment shown in FIG. 14, two parallel lines of circular holes 54 are formed in the partition means 44 to form the constricted fluid flow openings 48. As shown, the embodiment in FIG. 14 is not in accordance with the invention as all the holes are circular. However, it will be appreciated that the shape of one or more of the holes 54 can be varied such that they are non-circular. For example the holes 54 could be square.

In FIG. 15, the constricted flow openings 48 are formed by two spaced and parallel slots through the partition means 44.

Finally, FIG. 16 illustrates a partition means 44 having a constricted fluid flow opening formed my means of a U shaped hole.

All of the partition means 44 shown in FIGS. 4 to 16 may be flat or the front and rear surfaces may be shaped and they can be of any length. The shapes of the constricted fluid flow openings 48 may be constant over the length of the partition means or the shapes may be varied over their length.

The partition means 44 may be formed by a single projection 45 or wall or it may be formed from two or more projections or wall portions which combine together.

More than one partition means 44 can be provided in an expansion chamber 28 and a series of such partition means 44 may be provided in the same expansion chamber with small gap in between each one. Each of the partition means 44 in the series may be the same or at least some may of them may be of different configurations.

Partition means can be incorporated in to any suitable split-body atomising nozzle arrangement in accordance with the invention and are not limited to use in nozzle arrangements of the type shown in FIGS. 1 to 3 which is exemplary only.

Whilst the openings formed by or through the partition means 44 in accordance with the invention are constricted, they have a cross sectional area which is significantly larger than that of the final outlet orifice 18. It will be appreciated therefore, that the partition means in accordance with the invention are distinct from various known filter arrangements in which projections are used to define fluid flow openings that are necessarily smaller than the outlet orifice they are intended to protect.

Atomising nozzles in accordance with the invention are particularly suitable for use with aerosol canisters as they permit such canisters to generate an acceptable spray at lower operating pressures, which enables more efficient use to be made of the available propellant. Thus an aerosol canister fitted with a nozzle in accordance with the invention can be arranged to have an extended useful life as it can be used for longer as the pressure in the canister drops. Furthermore, when using a nozzle in accordance with the invention, the amount of propellant required in the canister to generate an acceptable spray is reduced. This is particularly beneficial for aerosol canisters that use a propellant containing vocs such as butane.

Whereas the invention has been described in relation to what is presently considered to be the most practical and preferred embodiments, it is to be understood that the invention is not limited to the disclosed arrangements but rather is intended to cover various modifications and equivalent constructions included within the spirit and scope of the invention. For example, the invention can be applied to nozzles adapted for use with any fluid or mixture of fluids suitable for emitting in the form of an atomised spray or mist regardless of viscosity or other properties. This includes nozzles adapted for use with a gas/liquid mixture, for example a mixture of air with liquor. The invention can be adapted for use in a wide variety of applications including nozzles for use with dispensers, such as aerosol canisters as discussed above but also with manually operated pump or trigger dispensers, as well as in industrial nozzles.

Where the terms “comprise”, “comprises”, “comprised” or “comprising” are used in this specification, they are to be interpreted as specifying the presence of the stated features, integers, steps or components referred to, but not to preclude the presence or addition of one or more other feature, integer, step, component or group thereof.

1. An atomising nozzle having an inlet through which fluid can enter the nozzle, an outlet orifice through which fluid can be ejected from the nozzle in the form of an atomized spray, and an internal fluid flow passageway which connects said inlet to said outlet orifice, said nozzle comprising a split body having two component parts, each component part having an abutment surface which contacts a corresponding abutment surface on the other of the parts, at least one of the abutment surfaces having at least one groove and/or recess formed therein to define at least part of the fluid flow passageway including an expansion chamber, the body further comprising a fixed partition means extending into the expansion chamber to define one or more constricted openings through which fluid is constrained to flow in order to pass from one side of the partition to the other within the chamber, the, or each, constricted opening having a cross sectional area larger than that of the final outlet orifice and being positioned outwardly of an axially central region of the expansion chamber so that the partition means blocks the flow of fluid through said axially central region and directs the fluid to flow generally axially about the periphery of the chamber, the, or at least one of the, constricted opening(s) being non-circular when viewed in lateral cross-section, characterised in that the partition means comprises a projection extending into the expansion chamber, said projection being formed on the abutment surface of one of the parts of the body and extending into a groove or recess in the other part of the body, the fluid flow passageway also comprising at least one further expansion chamber.

2. An atomising nozzle as claimed in claim 1, in which the expansion chamber is defined by means of corresponding recesses in the abutment surfaces of the two component parts of the body, said projection extending from a surface of the recess in one of the parts of the body into the recess in the other of the parts of the body.

3. An atomising nozzle as claimed in claim 2, in which the expansion chamber is defined by means of corresponding recesses in the abutment surfaces of the two parts of the body, the partition means comprising two projections, each projection extending inwardly toward the centre of the expansion chamber from a surface of the recess in a respective one of the parts of the body.

4. An atomising nozzle as claimed in any one of claims 1 to 3, in which the, or at least one of the, constricted opening(s) is formed by means of a hole or opening through said one or more projection.

5. An atomising nozzle as claimed in claim 1, in which the, or at least one of the, constricted opening(s) is formed between a periphery of said one or more partition and a wall of the expansion chamber.

6. An atomising nozzle as claimed in claim 1, in which the expansion chamber is shaped.

7. An atomising nozzle as claimed in claim 1, in which a surface of the, or at least one of the, constricted opening(s) is textured.

8. An atomising nozzle as claimed in claim 1, in which the size and/or shape of the, or at least one of the, constricted opening(s) varies in a longitudinal direction of the expansion chamber.

9. An atomising nozzle as claimed in claim 1, in which there are two or more of said partition means extending into the expansion chamber.

10. An atomising nozzle as claimed in claim 1, in which the partition means block the flow of fluid through an axially central region of the expansion chamber which has a cross sectional area larger than that of the outlet orifice.

11. An atomising nozzle as claimed in claim 1, in which the outlet orifice is provided in an insert which is received in body.

12. An atomising nozzle as claimed in claim 1, the nozzle having more than one outlet orifice.

13. An atomising nozzle as clamed in claim 1, in which the nozzle is adapted for use with an aerosol dispenser.

14. (canceled)

15. An aerosol canister comprising a nozzle as defined in claim 1.

16. An aerosol canister as claimed in claim 15, in which the canister contains a propellant comprising a volatile organic compound.

17. An aerosol canister as claimed in claim 16, in which the canister contains a propellant comprising butane.
